(19) United States
(12) Patent Application Publication
(10) Pub. No.: US 2003/0125970 A1
(43) Pub. Date: Jul. 3, 2003

(54) Method and system for real time interactive recruitment

(75) Inventors: Alok Mittal, New Delhi (IN); Vikas Agarwal, New Delhi (IN); Shrutipriya Dalmia, New Delhi (IN)

Correspondence Address: William L. Botjer, PO Box 478, Center Moriches, NY, 11934, US

(73) Assignee: WebNeuron Services Ltd.

(21) Appl. No.: 10/039,708

(22) Filed: Dec. 31, 2001

(51) Int. Cl. G06F 17/60

(52) U.S. Cl. 705/1

(57) ABSTRACT

A method, system and computer program for providing real time online interactive recruitment. The method, system and computer program enables a job seeker to select a company of his choice through a selling process initiated by a recruiter over the network. The method, system and computer program further enables the recruiter in giving presentations of the selected companies to the job seeker. The method, system and computer program also allows the selected companies to take interview of the job seekers. The method, system and computer program also aids the recruiter in handling more than one job seeker during the online selling process.

### BACKGROUND OF THE INVENTION

1. Field of the Invention

The present invention relates to real time online interactive recruitment. More particularly, the present invention deals with a method, system and computer program for enabling a job seeker to select jobs of his choice through a process initiated by a recruiter or by the job seeker himself, and for enabling the conducting of online interviews with respect to the companies short-listed by the job seeker.

2. Description of the Related Art

Traditionally, the most common recruiting method has been advertising through newspapers or magazines. An advertisement in a newspaper or a magazine typically comprises a description of an available job along with the address, telephone number, facsimile number and email address of the employer. Various job seekers can apply for the advertised job by sending their resume directly to the employer via regular mail, facsimile, or an email. Once the employer receives the resumes, certain applicants are identified and interviewed. There are many disadvantages that are inherent in this conventional method. For example, an advertisement in a magazine or a newspaper would have limited readership and therefore many eligible job seekers might miss the same. Further, these advertising methods require continuous monitoring by a job seeker on a regular basis in order to ascertain whether a specific employment opportunity is available or not.

Another conventional method adopted by both employers and job seekers is to contact a professional recruiter for matching job seekers with job vacancies. But the resources available to professional recruiters tend to limit their efforts. For instance, when a company looking for suitable job seekers engages a professional recruiter, the recruiter may have to undertake “cold calling” suitable job seekers (who may even be employed by other companies). Further, these recruiters may also be required to network with other recruiters to obtain names of potential job seekers. Conversely, when a job seeker looking for a suitable position contacts a recruiter, the recruiter may have to identify a “proper matching” position and the corresponding employer. Such an effort is very resource intensive on the part of the recruiter and the recruiter usually charges a hefty fee for this effort. Moreover, in spite of using all the resources at hand, it is possible that a recruiter may overlook suitable job seekers and/or available positions. Therefore, due to its expensive and non-exhaustive nature, hiring a professional recruiter is not the most efficient option for either the job seeker or the company.

The evolution of Internet has helped in addressing some of the problems faced by traditional methods of recruitment. The advent of Internet has provided recruiters with an easier access to job seekers; indeed, it provides access to both those job seekers contemplating an immediate move and to those that could be persuaded if the right job presents itself. Internet is playing a substantial role in recruitment as a “direct marketing, advertising and matching channel”.

Companies are using Internet to target potential job seekers by having web pages, electronic bulletin boards etc. An employer would typically have a home page or some other user interface on Internet, where job seekers can post their resumes.

Recruiters are also using Internet primarily as a source for getting “raw” resumes. Various recruiters maintain websites such as http://www.careermosaic.com that primarily use an electronic bulletin board on which jobs/resumes can be posted. A job seeker can log onto the bulletin board to peruse available positions. However, these bulletin boards merely offer an aggregation of “raw” resumes and available jobs but lack any interactive session between the recruiter and the job seeker. Further, they do not attract and match relevant job seekers in a targeted manner in real time. For example, it often takes several days from the time a job seeker has posted his/her resume to the time the recruiter approaches the job seeker with relevant jobs. Often, during this period, either the job seeker is no longer interested in the job or he/she may have already found another job. This is especially true for highly skilled job seekers who are in great demand. Such job seekers need to be attracted proactively and interactively, rather than through a media advertisement—whether it be on Internet or in newspapers. In such a scenario, lack of real time interaction between a recruiter and a job seeker is an impediment to matching the job seeker with available job vacancies. Along with absence of real time interaction, certain other critical issues that may be essential for matching a job seeker to a suitable job vacancy are also not addressed. For example, the aspect of guiding the job seeker and convincing him/her regarding suitability of available jobs is not addressed by the bulletin boards. They also do not address softer issues of job selling such as job seeker's interest and preferences. It seems that these aspects can be brought about by real time interaction between job seekers and recruiters.

There are various sites such as http://www.employdirect.co.uk and http://www.monster.com that offer a chat service along with a bulletin board service. The chat feature supported by http://www.employedirect.co.uk is merely a platform for various people to interact with each other. This chat feature does not specifically deal with recruitment. More so, there is no real time interaction between the job seeker and a recruiter or a prospective employer. The chat service provided by http://www.monster.com is primarily aimed at discussions on various topics ranging from health care tips to interview tips. These discussions are on topics that are predetermined. Also, these discussions take place at predetermined times, which are posted on the website on a monthly basis.

All the abovementioned sites that provide chat services merely use the chat interface to make the job seeker's browsing experience better. None of them provides for a complete recruitment service where the job seeker may be offered a job opportunity shortly after the completion of the chat session. The recruiters on these sites merely counsel the job seeker about various available jobs and help the job seeker in building and posting of a resume.

There are various existing patents dealing with recruitments. U.S. Pat. No. 5,884,270 which is titled “Method and system for facilitating an employment search incorporating user-controlled anonymous communications” discloses a system for facilitating employment searches using communication between the employer and the job seeker but at the same time, keeping their respective identities anonymous. U.S. Pat. No. 5,978,768 which is titled “Computerized job search system and method for posting and searching job openings via a computer network” discloses a job search method and system that enables an employer to advertise for available job positions, receive resumes from prospective job seekers and then effectively screen and organize the same. However, these patents do not deal with real time interaction between jobseekers and employers.

Therefore, what is needed is a method, system and computer program for obliterating the abovementioned drawbacks in the prior art wherein a recruiter and a job seeker can interact in real time, when the job seeker is most amenable for seeking a job. A need also exists for a method, system and computer program wherein the recruiter can sell a job opportunity to the job seeker during the real time online interaction.

### SUMMARY OF THE INVENTION

An object of the present invention is to provide a method, system and computer program for real time online interactive recruitment, whereby a recruiter is able to contact a job seeker in real time when the job seeker is most interested in a job.

Another object of the present invention is to provide a method, system and computer program that enables the job seeker to short-list companies of his choice through a selling process initiated by the recruiter.

Yet another object of the present is to enable recruiters use the online process for giving presentations of the companies selected by the job seeker, to further narrow down the job seeker's choice of companies.

Still another object of the present invention is to provide a method, system and computer program in which the companies short-listed by the job seeker could conduct online interviews with the job seeker.

A further object of the present invention is to provide a method, system and computer program wherein the recruiter can sell a job opportunity to the job seeker during their online real time interaction.

Other objects and advantages of the present invention will be set forth in part in the description and in the drawings which follow and, in part, will be obvious from the description or may be learned by practice of the invention.

To achieve the foregoing objects, and in accordance with the purpose of the present invention as broadly described herein, the present invention provides for a method, system and computer program for use in real time interactive online recruitment. Preferably, a job seeker visits a network site and performs a job seeking action. These actions could be posting of resume, applying for jobs, searching for specific jobs, editing of resume and other such related actions. Based on these actions, the job seeker profile is then intelligently routed to a specific recruiter. Various rules are specified, either manually or automatically, for routing the job seeker profile to the specific recruiter. The recruiter here refers to be a professional in the external recruiting company or somebody who is hired by a company seeking candidates.

The recruiter then initiates a selling process with the job seeker to enable him find a suitable job. The selling process could be online through a net-based conversation or offline through an email, a telephone call or a facsimile. During the selling process, the recruiter may administer online tests to assess various skill sets of the job seeker. The job seeker may give continuous feedback to the recruiter, on the basis of which the recruiter refines the list of suitable jobs and offers a job opening to the job seeker. The selling process ends with the job seeker finally selecting a job or a set of potential jobs. Thereafter, the complete process is captured and saved in the relevant database.

The present invention will now be described with reference to the following drawings, in which like reference numbers denote the same elements throughout.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a block diagram of a computer workstation environment in which the present invention may be practiced;

FIG. 2 is a diagram of a networked computing environment in which the present invention may be practiced;

FIG. 3 is an illustration of an online interactive recruitment method according to an embodiment of the present invention;

FIG. 4 is a flowchart that illustrates the information capturing process (from the job seeker);

FIG. 5 shows a job seeker information entry screen;

FIG. 6 is a flowchart that illustrates mapping of job seeker information onto recruiter administrator;

FIG. 7 is a flowchart that illustrates recruiter information database being updated;

FIG. 8 shows a routing data capture screen;

FIG. 9 is a flowchart that illustrates recruiter side chat initiation process;

FIG. 10 shows a recruiter chat initiation screen;

FIG. 11 is a flowchart that illustrates job seeker side chat initiation process;

FIG. 12 shows a job seeker chat initiation screen;

FIG. 13 shows a recruiter chat window screen;

FIG. 14 shows a job seeker chat window screen;

FIG. 15 shows a job information screen; and

FIG. 16 is a flowchart that illustrates capturing of job seeker information and job seeker preferences.

### DESCRIPTION OF PREFERRED EMBODIMENTS

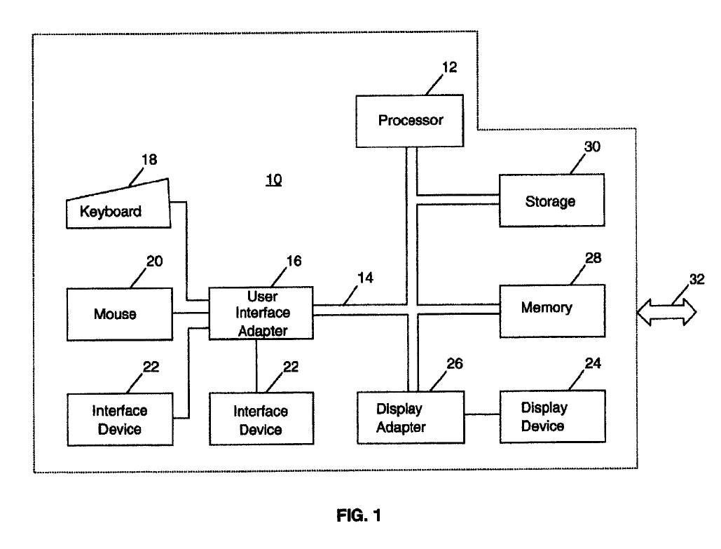

FIG. 1 illustrates a representative workstation hardware environment in which the present invention may be practiced. The environment of FIG. 1 comprises a representative single user computer workstation 10, such as a personal computer, including related peripheral devices. The workstation 10 includes a microprocessor 12 and a bus 14 employed to connect and enable communication between the microprocessor 12 and the components of workstation 10 in accordance with known techniques. Workstation 10 typically includes a user interface adapter 16, which connects microprocessor 12 via bus 14 to one or more interface devices, such as a keyboard 18, a mouse 20, and/or other interface devices 22, which can be any user interface device, such as a touch sensitive screen, digitized entry pad, etc. Bus 14 also connects a display device 24, such as an LCD screen or monitor, to the microprocessor 12 via a display adapter 26. Bus 14 also connects the microprocessor 12 to a memory 28 and long-term storage 30 which can include a hard drive, diskette drive, tape drive, etc.

Workstation 10 communicates via a communications channel 32 with other computers or networks of computers. Workstation 10 may be associated with such other computers in a local area network (LAN) or a wide area network or the Internet, or workstation 10 can be a client in a client/server arrangement with another computer, etc. All of these configurations, as well as the appropriate communications hardware and software, are known in the art.

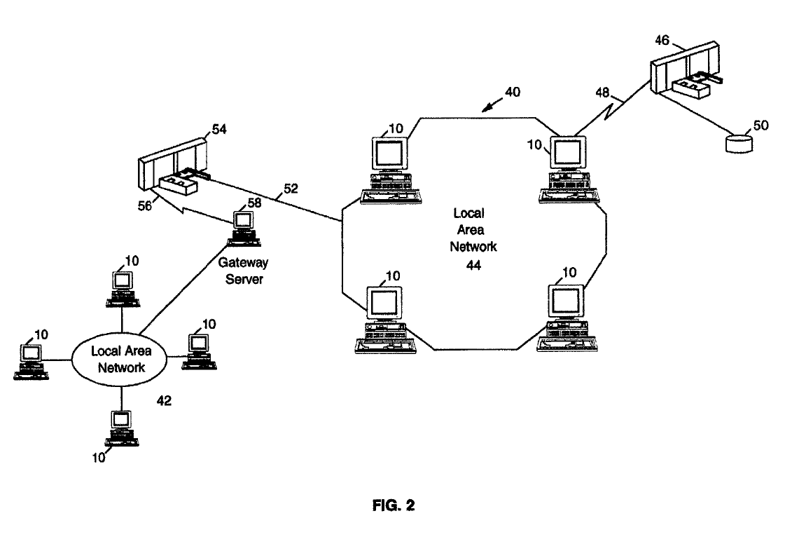

FIG. 2 illustrates a data processing network 40 in which the present invention may be practiced. The data processing network 40 includes a plurality of individual networks, including LANs 42 and 44, each of which includes a plurality of individual workstations 10. Alternatively, as those skilled in the art will appreciate, a LAN may comprise a plurality of intelligent workstations coupled to a host processor.

Still referring to FIG. 2, data processing network 40 may also include multiple mainframe computers, such as a mainframe computer 46, which may be preferably coupled to LAN 44 or WAN or the Internet by means of a communications link 48.

Mainframe computer 46 may also be coupled to a storage device 50, which may serve as remote storage for LAN 44. Similarly, LAN 44 may be coupled to a communications link 52 through a subsystem control unit/communication controller 54 and a communications link 56 to a gateway server 58. Gateway server 58 is preferably an individual computer or intelligent workstation which serves to link LAN 42 to LAN 44.

Those skilled in the art will appreciate that mainframe computer 46 may be located a great geographic distance from LAN 44, and similarly, LAN 44 may be located a substantial distance from LAN 42.

Software programming code that embodies the present invention is typically accessed by microprocessor 12 of workstation 10 from long-term storage media 30 of some type, such as a CD-ROM drive or hard drive. In a client-server environment, such software programming code may be stored with storage associated with a server. The software programming code may be embodied on any of a variety of known media for use with a data processing system, such as a diskette, hard drive, or CD-ROM. The code may be distributed on such media, or may be distributed to users from the memory or storage of one computer system over a network of some type to other computer systems for use by users of such other systems. Alternatively, the programming code may be embodied in memory 28, and accessed by microprocessor 12 using bus 14. The techniques and methods for embodying software programming code in memory, on physical media, and/or distributing software code via networks are well known and will not be further discussed herein.

Various databases used in the present invention may be stored on any of the various media types used by long-term storage 30, or may be sent from workstation 10 to another computer or workstation or network illustrated in FIG. 2 over communications channel 32, for storage by that other computer or work station.

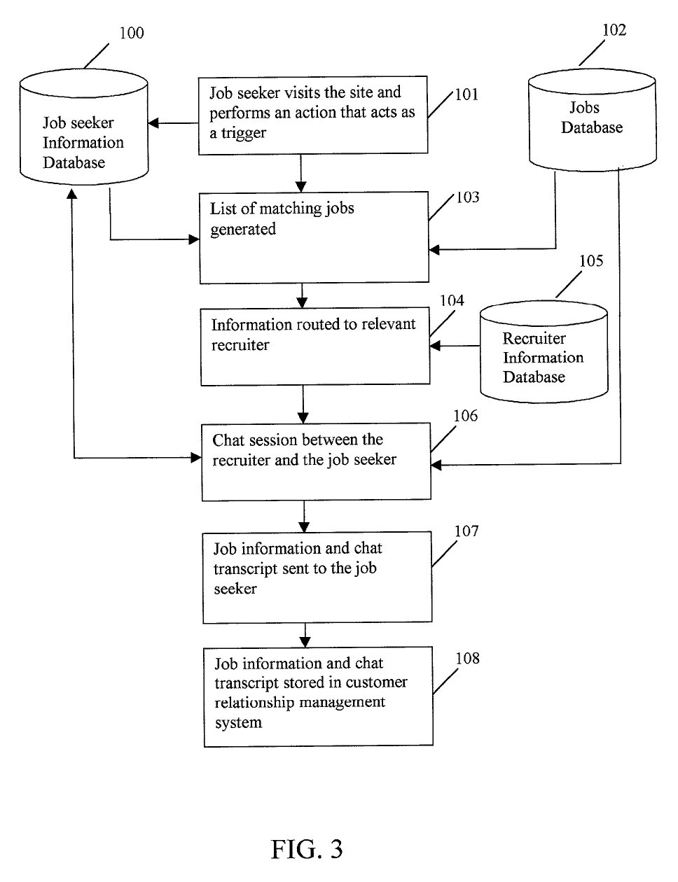

The preferred embodiments of the present invention will now be discussed with reference to FIGS. 3 through FIG. 16. In the preferred embodiments, the present invention is implemented as a computer software program. The software may execute on a remote computer that may be connected to the user's computer through a LAN or a WAN that is part of a network owned or managed internally to the user's company, or the connection may be made through the Internet using an ISP. What is common to all applicable environments is that the user accesses a public network, such as the Internet, through his computer, thereby accessing the computer software that embodies the invention.

Referring now primarily to FIG. 3, an illustration of a real time online interactive recruitment method and system, according to an embodiment of the present invention, is described in detail. A job seeker visits an online recruitment site and performs a job seeking action that acts as a trigger 101. Trigger 101 notifies a recruiter administrator about the presence of the job seeker on the site. The recruiter administrator could either be an automated router or implemented manually. The actions performed by the job seeker that act as a trigger might involve posting or editing of his resume, posting of a desired job profile, searching for a job and the like. This information is captured and then stored in a job seeker information database 100. The recruiter administrator uses the information given by the job seeker to generate a preliminary list of matching jobs 103 using a jobs database 102 that contains information about all the available jobs. The recruiter administrator also has access to a recruiter information database 105 that contains information pertaining to the kind of jobs a recruiter can handle, availability of a recruiter, current load on a recruiter, and the like. Using a recruiter information database 105, the recruiter administrator routes the preliminary list of matching jobs along with the job seeker information to a relevant recruiter 104.

The relevant recruiter then sends a request for a chat session to the job seeker. Once a chat session begins 106, the recruiter discusses job seeker's queries, preferences and capabilities with the job seeker. This information is stored in job seeker information database 100. The recruiter thereafter refreshes the list of matching jobs according to the information given by the job seeker. Subsequently, the recruiter offers the job seeker a set of suitable jobs. After the chat ends, this job information along with a chat transcript is sent to the job seeker 107 preferably by means of an email and is also stored in a customer relationship management system 108.

Job seeker information is captured by a job seeker information capture module. This module captures job seeker's resume and desired job preferences when the job seeker visits the site. It also captures additional information about the job seeker from the chat session between the job seeker and the recruiter.

Any action performed by the job seeker on the site that acts as a trigger, is captured by a job seeker trigger capture module. This module also notifies the recruiter administrator about the presence of the job seeker on the site.

The chat session between the job seeker and the recruiter is enabled by a chat session module. This module provides for the recruiter and job seeker to chat with each other, for the recruiter to give presentation of selected companies to the job seeker, and for the recruiter to conduct online tests to assess the skills and capabilities of the job seeker.

These modules are implemented in software. In an alternative embodiment of the present invention, the abovementioned modules may be implemented in hardware. This will entail programming the modules in a low level language and then burning it on a ROM or embedding it on an IC. Thereafter, the IC will be embedded on the host's machine so as to speed up the working of the modules.

In another alternative embodiment of the present invention, the recruiters are representatives of the companies that are looking for job seekers. The company then specifies routing rules for resumes, get direct access to the job seeker, convinces the job seeker about the jobs with them, pre-screens the job seeker and finally makes an offer of employment while the job seeker is still available on the online recruitment site. Hence, the company has full control on the recruiting process and is not dependent on the online recruitment site for pre-screening and final selection of job seekers.

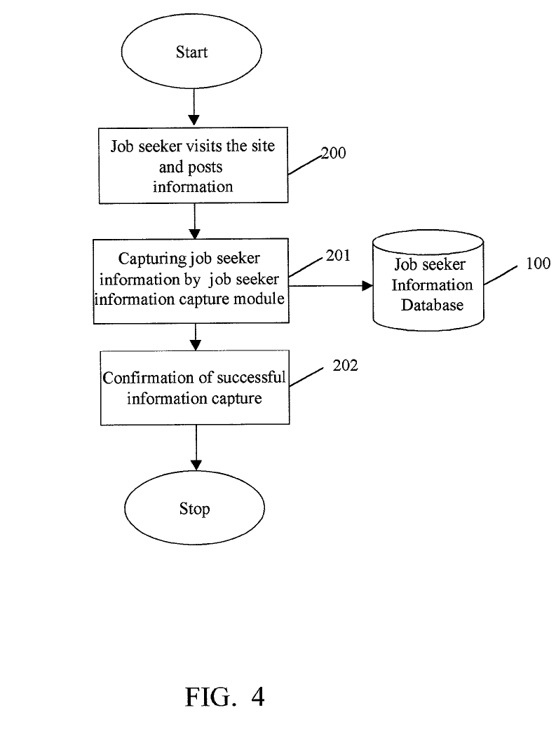

Referring now primarily to FIG. 4, a flowchart that illustrates the information capturing process from the job seeker is described in detail. The job seeker visits the site 200 and posts his resume and other details as well as his job preferences and a description of his dream job on the site. This information is captured at 201 and stored in job seeker information database 100. The capturing of job seeker information is done by job seeker information capture module. The job seeker is then flashed a confirmation 202 of the information being successfully stored in job seeker information database 100.In an alternative embodiment, confirmation 202 may be provided by an email sent to the job seeker.

In another alternative embodiment, the information provided by the job seeker may be used for registering the job seeker on the site.

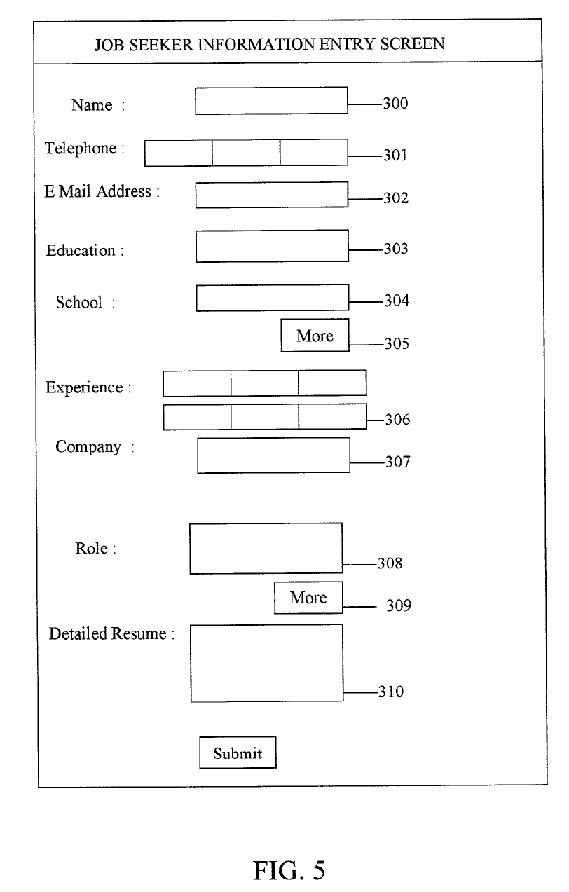

Referring now primarily to FIG. 5, a job seeker information entry screen is described in detail. The job seeker information entry screen comprises fields pertaining to a name 300, a telephone 301, an email address 302, education 303, a school 304 along with professional details like number of years of experience 306 with the corresponding a company name 307, a role 308 in that company and a detailed resume 310. In the event the job seeker wants to enter additional details he can do the same by clicking on a relevant link 305 (for additional schooling information) or a link 309 (for additional work information).

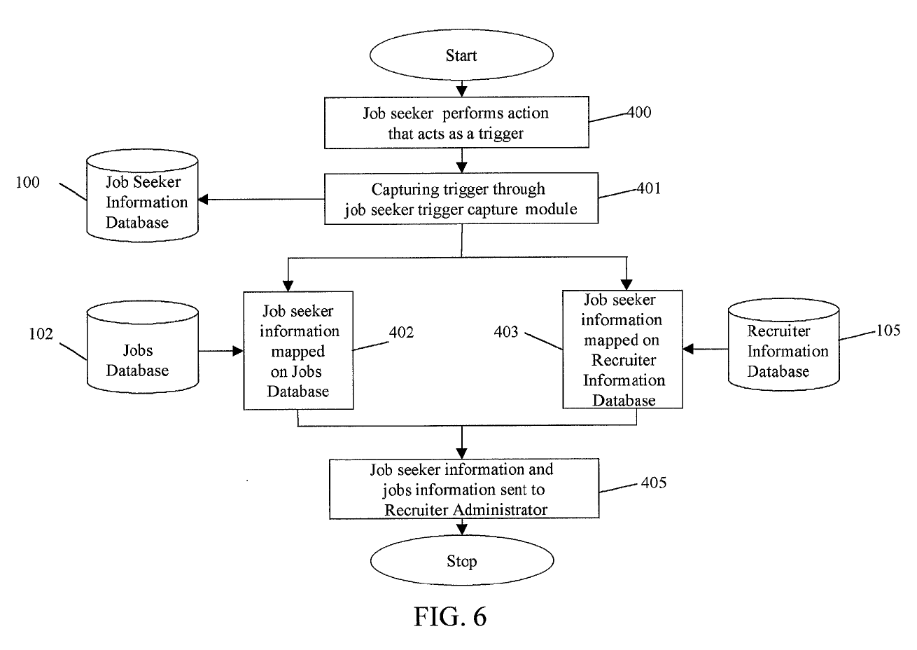

Referring now primarily to FIG. 6, a flowchart that illustrates mapping of job seeker information onto the recruiter administrator is described in detail. The job seeker performs an action which acts as a trigger 400, that is captured through a job seeker trigger capture module 401 and stored in job seeker information database 100. Trigger 400 could be any action performed by the job seeker (such as posting of resume, updating of resume, searching for jobs, searching for companies, logging on to the site etc.) indicating the job seeker's interest in the job. The job seeker trigger capture module recognizes an activity on part of the job seeker on the site and also helps in notifying the recruiter administrator about the presence of the job seeker on the site. The job seeker information (i.e. resume, dream job posting etc.) is mapped on the jobs database at 402 to generate a list of matching jobs. The job seeker information is also mapped at 403 on recruiter information database 105 to generate a list of recruiters. Thereafter the job seeker information and jobs information is sent to a recruiter administrator 405.The information regarding routing of a job seeker to the recruiter is in the recruiter information database 105. In recruiter information database 105 a set of rules exist which specify how a particular type of job seeker, based on the job seeker information, is to be handled. It may also specify a recruiter to whom the job seeker should be routed to. These rules are specified either manually or automatically based on the recruitment assignments being handled by any particular recruiter. The rules can also take into account load distribution amongst recruiters who have the capability to handle similar profiles of job seekers. Multiple rules may be invoked, and the information may be routed to one or more recruiters. The rules might be based on explicit information provided by the job seeker or on information deduced while chatting with the job seeker.

Recruiter information database 105 contains rules based on profiles of job seekers, loading of recruiters, jobs available with specific recruiters, currently active recruiters and priority of specific recruiters and the like.

In an alternative embodiment of the present invention, the triggers can be offline and lead to a similar process with larger cycle times.

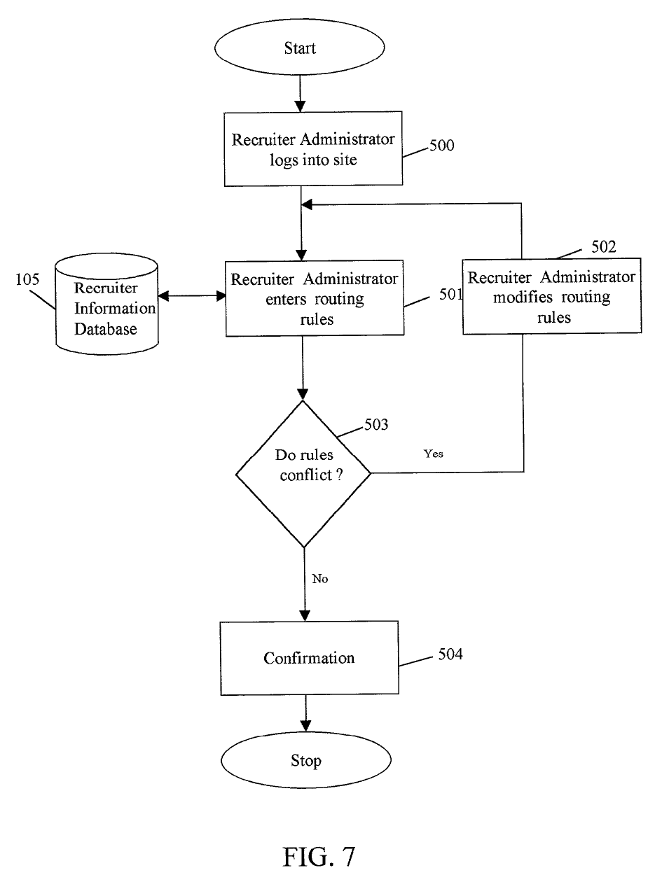

Referring now primarily to FIG.7, a flowchart that illustrates recruiter information database 105 being updated is described in detail. The recruiter administrator logs onto the site at 500 and enters routing rules 501. These rules are stored in recruiter information database 105. If the rules do not conflict at 503 with already existing rules, a confirmation is given at 504, else the recruiter administrator modifies and resubmits the rule at 502.

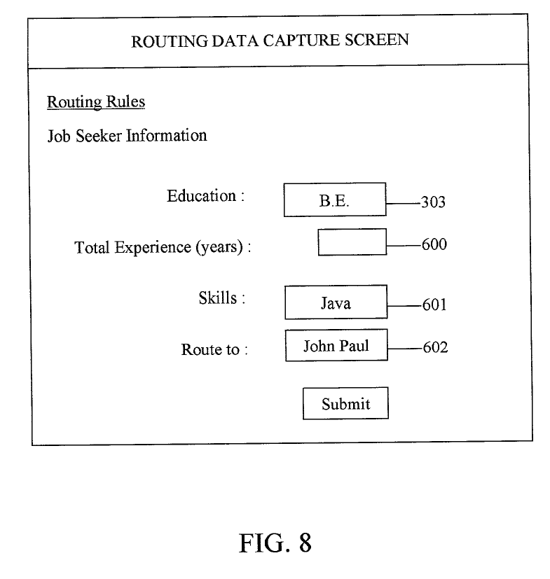

Referring now primarily to FIG. 8, a routing data capture screen is described in detail. The routing data capture screen has the fields pertaining to education 303, total experience 600, skills 601 and a field for routing to a relevant recruiter 602.

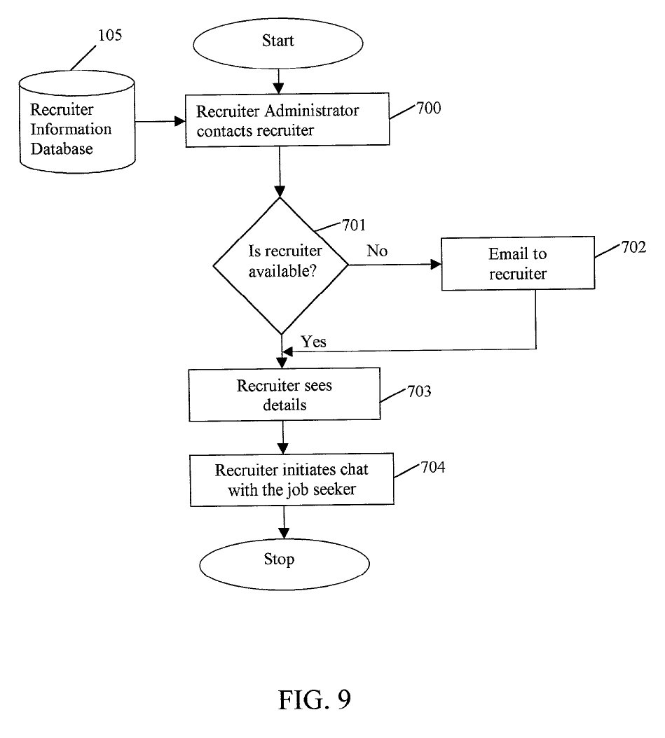

Referring now primarily to FIG. 9, a flowchart that illustrates recruiter side chat initiation process is described in detail. Chat session module enables the recruiter to interact with the job seeker. The recruiter administrator using recruiter information database 105 contacts the at recruiter 700. If the recruiter is available at 701, he sees the details at 703 and initiates a chat with the job seeker at 704. If the recruiter is not available, the recruiter administrator sends an email to the recruiter at 702.

An online recruiter gets the information on his computer. The information presented to the recruiter includes job seeker information, his dream job description and currently active jobs that meet some or all of job seeker's criteria. With each job is associated a priority which is a function of the job profile and job seeker's preferences. The recruiter can then scan this information and immediately contact the job seeker through an online mechanism while the job seeker is still on the site.

In case job seeker information does not exactly match any job profile with the recruiter, the recruiter can relax some criteria specified by the job seeker to generate other matches for the job seeker.

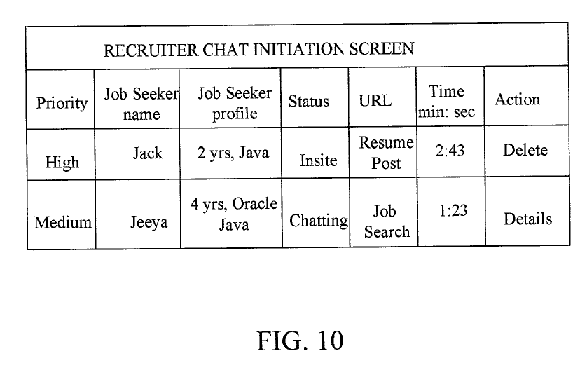

Referring now primarily to FIG. 10, a recruiter chat initiation screen is described in detail. The recruiter chat initiation screen comprises fields pertaining to priority, job seeker name, job seeker profile, status, URL, time and action. The recruiter sets the priority of each job seeker. The action of the recruiter could be deleting the job seeker from his chat screen, asking for more details about the job seeker (which will result in the job seeker receiving a chat request from the recruiter) etc.

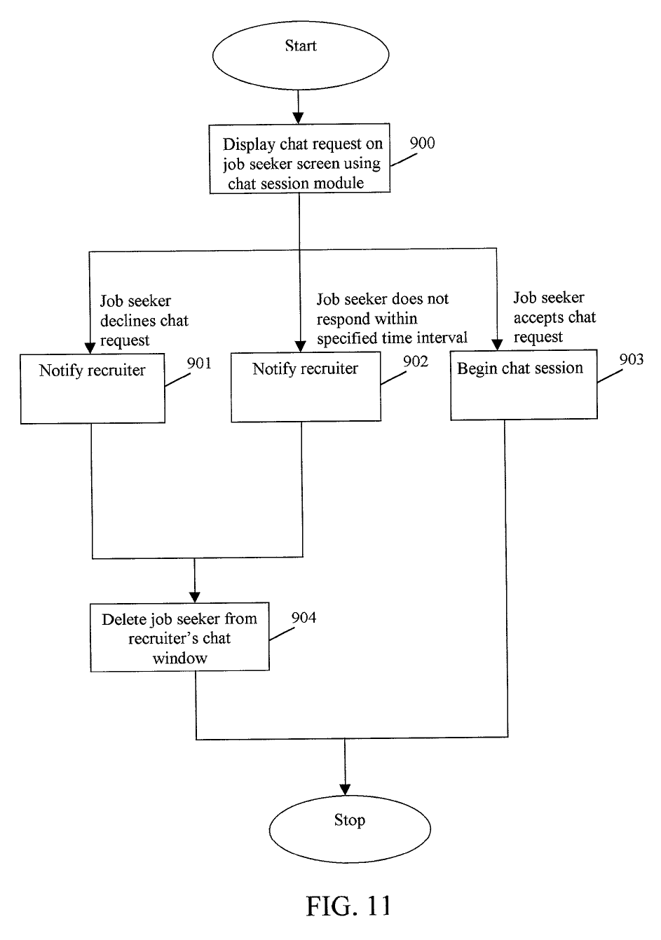

Referring now primarily to FIG. 11, a flowchart that illustrates job seeker side chat initiation process is described in detail. The chat session module enables the job seeker to interact with the recruiter and vice versa.

The recruiter sends the job seeker a request for an interactive session and a chat request is displayed on the job seeker screen at 900. The job seeker can either accept the offer or decline it. In case the job seeker accepts the offer, chat session begins at 903. In case he declines the offer, the recruiter is notified at 901 and the job seeker is deleted from recruiter's chat window at 904. Also in case when the job seeker doesn't respond within specified time duration, the recruiter is notified at 902 and the job seeker is deleted from the recruiter's chat window at 904. The relevant job information is provided to the job seeker by means of an email irrespective of whether a chat is initiated or not.

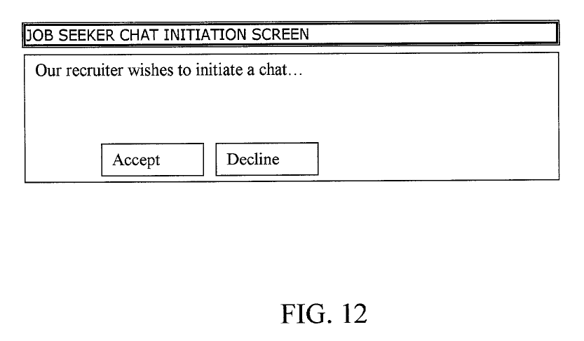

Referring now primarily to FIG. 12, a job seeker chat initiation screen is described in detail. The job seeker chat initiation screen provides the job seeker with the option of either accepting or declining recruiter's offer for an interactive chat session.

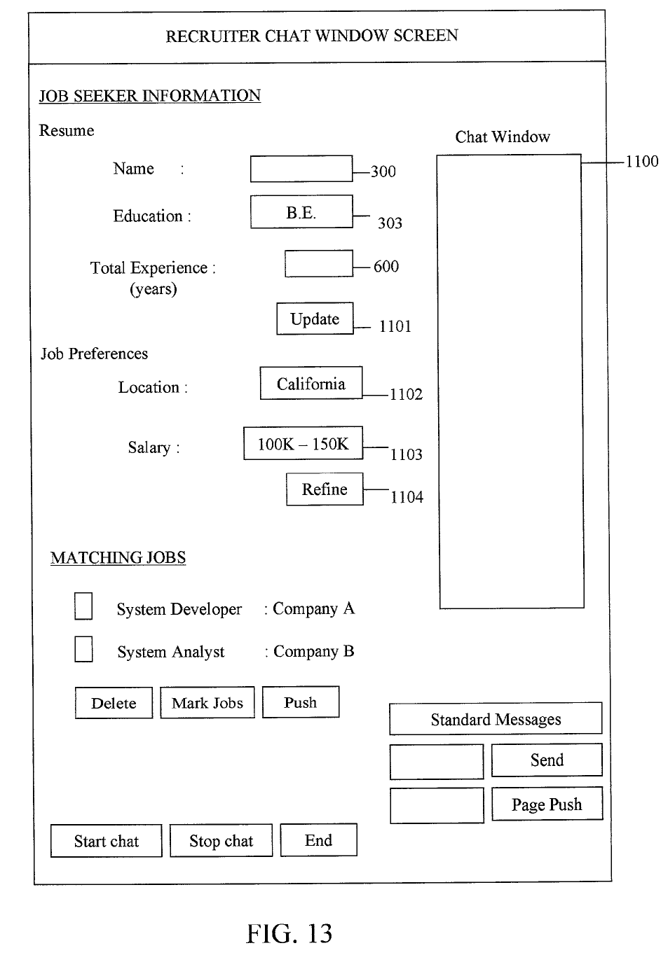

Referring now primarily to FIG. 13, a recruiter chat window screen is described in detail. The recruiter chat window screen shows the summary of job seeker information, matching jobs and chat window. The job seeker information section includes fields pertaining to name 300, education 303, total experience 600 along with job preferences comprising a location 1102 and a salary 1103. Matching jobs is a list of jobs presented by the recruiter to the job seeker. A chat window 1100 shows the contents of the communication that happens between the recruiter and the job seeker. Once the recruiter and the job seeker are in an interactive chat session, the recruiter suggests available jobs to the job seeker and gets his feedback. Based on the interaction, the recruiter continuously refines job seeker information by clicking on the update at button 1101, and generates superior job matches for the job seeker by clicking on a refine 1104 button. Recruiter chat window screen must enable successive refinement of job seeker information and quick search update for relevant jobs.

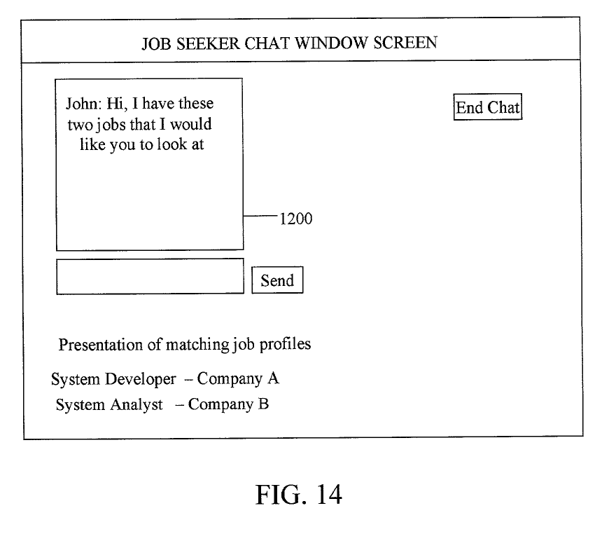

Referring now primarily to FIG. 14, a job seeker chat window screen is described in detail. A job seeker chat window 1200 shows the chat text written by the recruiter to the job seeker.

In a preferred embodiment of the present invention, the recruiter has the capability to display job and company profiles to the job seeker using the same interface. This can be done, for example, by pushing web pages containing such information. Multimedia and other tools may also be used rather than just a text based interaction.

All the capabilities to perform functions listed above which include interactive session between the job seeker and the recruiter are enabled through the chat session module.

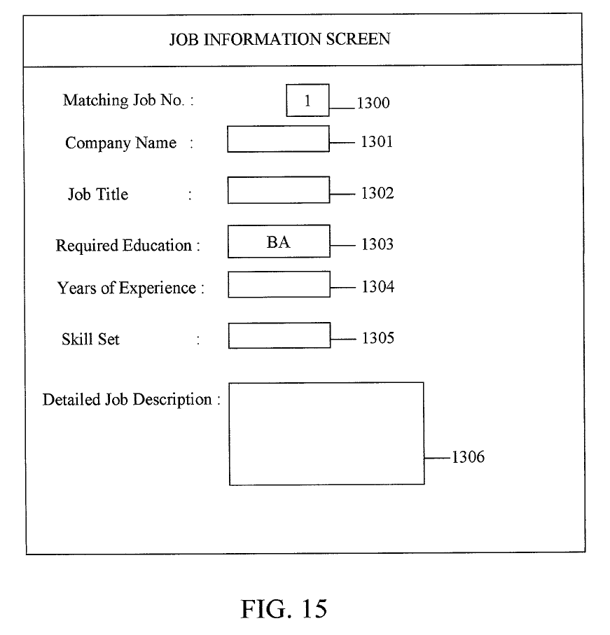

Referring now primarily to FIG. 15, a job information screen is described in detail. The job information screen shows various fields i.e. a matching job no. 1300, a company name 1301, a job title 1302, the required education 1303, the years of experience 1304, skill set 1305 and a detailed job description 1306.

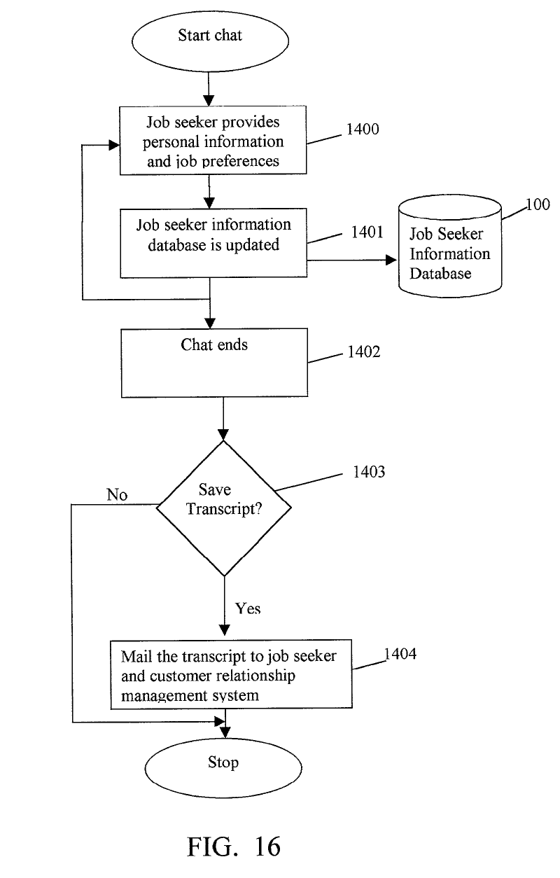

Referring now primarily to FIG. 16, a flowchart that illustrates capturing of job seeker information and job seeker preferences is described in detail. The job seeker provides personal information and job preferences at 1400 during the chat session that is stored in job seeker information database 100, and then job seeker information database 100 is updated at 1401. After the chat session ends at 1402, the recruiter has the option at 1403 wherein all the information about the job seeker, the interaction transcript and matched jobs can be saved in job seeker information database and can be fed into a customer relationship management system for further follow-up and closure. The interaction transcript is also mailed at 1404 to the job seeker.

In an alternative embodiment of the present invention, the recruiter, in the course of the interactive session with the job seeker, can also administer questions or tests to assess the skill or personality traits of the job seeker, and thus determine the suitability of the job for the job seeker in a better way. Such tools can be structured for easy administration.

In another alternative embodiment of the present invention, the recruiter may help the job seeker build his professional resume. The job seeker may visit the site and ask for online professional resume building services.

In yet another alternative embodiment of the present invention, the recruiter may give an online or an offline presentation of selected companies to the job seeker. This may further narrow down the choice for selection of companies by the job seeker.

In yet another embodiment of the present invention, the recruiter may initiate an online or an offline interview of the job seeker with the companies selected by the job seeker.

In yet another embodiment of the present invention, all the communication can happen using wireless networks (including those that use Wireless Application protocol (WAP), Short Message Systems (SMS), Bluetooth protocols and the like) as well. In this embodiment, the job seeker will log onto the WAP enabled network site using his Cellular Phone or Personal Digital Assistant (e.g. Palm Pilots) or Thin-Clients (i.e. PCs and PC-like machines that have lower requirements with respect to processing, memory, battery etc). The recruiter will also have a mobile telephone and the chat between the job seeker and the recruiter will happen using the mobile phone. The recruiter administrator will still be required to route the job seeker information to the relevant recruiter. It is useful, as the job seeker does not have to access the network site using a computer. Also even if the recruiter is away, he can still be contacted.

In yet another embodiment of the present invention, the list of jobs finally selected by the job seeker can be saved in a job seeker information database. This database also stores other preferences of the job seeker gathered while chatting with the job seeker (besides the one already mentioned in the job seeker information capture screen).

Systems such as email and customer relationship management are assumed to be external interface modules to this system.

As is well known to those skilled in the art the data processing and communication described herein can be implemented in a wide variety of well known programming languages and programming tools, While the preferred embodiment of the present has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope the invention.

What is claimed is:

1. A method for enabling real time interaction for recruitment between a job seeker and a recruiter, said job seeker having performed a job seeking action that entails inputting of job seeker information on a network site through an interface, said method for enabling real time interaction comprising the steps of:
a. capturing of said job seeking action performed on said network site by said job seeker;
b. routing of said job seeker information to said recruiter; and
c. selling of jobs to said job seeker by said recruiter.

2. The method according to claim 1, wherein said job seeking action is posting of resume.

3. The method according to claim 1, wherein said job seeking action is editing of resume.

4. The method according to claim 1, wherein said job seeking action is searching for jobs.

5. The method according to claim 1, wherein said job seeking action is posting of desired job information.

6. The method according to claim 1, wherein said routing comprises the steps of:
a. logging onto said network site by a recruiter administrator;
b. mapping of said job seeker information on a recruiter information database by said recruiter administrator, to find a suitable recruiter;
c. mapping of said job seeker information on a jobs database by said recruiter administrator, to generate list of matching jobs; and
d. sending said job seeker information and said list of matching jobs to said suitable recruiter.

7. The method according to claim 1, wherein said routing is automated.

8. The method according to claim 1, wherein said routing is manual.

9. The method according to claim 1, wherein said selling of jobs comprises the steps of:
a. contacting of said recruiter by said recruiter administrator;
b. if said recruiter is not available, sending an email to the said recruiter; and
c. if said recruiter is available, initiation of chat by said recruiter with said job seeker.

10. The method according to claim 9, wherein said initiation of chat with said job seeker comprises the steps of:
a. displaying a chat request on job seeker interface;
b. if said job seeker declines chat request, deleting job seeker from recruiter chat window;
c. if said job seeker does not respond, deleting job seeker from recruiter chat window; and
d. if said job seeker accepts the chat request, beginning of chat session between said job seeker and said recruiter.

11. The method according to claim 10, wherein said chat session comprises short-listing of companies by said job seeker.

12. The method according to claim10, wherein said chat session comprises giving of presentations by said recruiter of companies short-listed by said job seeker.

13. The method according to claim 1, wherein said selling of jobs comprises updating of matching jobs according to the interaction between said job seeker and said recruiter.

14. The method according to claim 1, wherein said selling of jobs comprises emailing of said chat session's transcript to said job seeker after said chat session is over.

15. The method according to claim 1, wherein said selling of jobs comprises adding of said transcript to Customer Relationship Management Database.

16. The method according to claim 1, wherein said selling of jobs comprises an Internet based interaction.

17. The method according to claim 1, wherein said selling of jobs comprises cellular phone network based interaction.

18. The method according to claim 1, wherein said selling of jobs is conducted simultaneously with a plurality of job seekers.

19. The method according to claim 1, wherein said selling of jobs is conducted simultaneously by a plurality of recruiters.

20. A system for enabling real time interaction for recruitment between a job seeker and a recruiter, said job seeker having performed a job seeking action that entails input of job seeker information on a network site through an interface, the system comprising:
a. a job seeker trigger capture module;
b. a job seeker information capture module;
c. a routing module; and
d. a chat session module.

21. The system according to claim 20, wherein said job seeker trigger capture module is a means for capturing any action performed by said job seeker while he is on said network site.

22. The system according to claim 20, wherein said job seeker information capture module is a means for capturing job seeker information.

23. The system according to claim 20, wherein said routing module comprises:
a. means for logging onto said network site by a recruiter administrator;
b. means for mapping of said job seeker information on a recruiter information database to find a suitable recruiter, by said recruiter administrator;
c. means for mapping of said job seeker information on a jobs database by said recruiter administrator, to generate list of matching jobs; and
d. means for sending said job seeker information and said list of matching jobs to said suitable recruiter.

24. The system according to claim 20, wherein said chat session module comprises a means for enabling an interactive chat session between said job seeker and said recruiter.

25. The system according to claim 20, wherein said chat session module enables said recruiter to give presentations of selected companies to said job seeker.

26. The system according to claim 20, wherein said chat session module enables said recruiter to conduct online tests so as to assess the skills and capabilities of said job seeker.

27. A computer program product for enabling real time interactive recruitment between a job seeker and a recruiter, said job seeker having performed a job seeking action that entails input of job seeker information on a network site, the computer program product embodied on one or more computer readable media and comprising:
a. a computer readable program code means for capturing said job seeking action on said network site by said job seeker;
b. a computer readable program code means for routing of said job seeker information by said recruiter; and
c. a computer readable program code means for selling of jobs by said recruiter to said job seeker.

28. The computer program product according to claim 27, wherein said computer readable program code means for routing of said job seeker information by said recruiter comprises:
a. a computer readable program code means for mapping of said job seeker information on a recruiter information database to find a suitable recruiter, by said recruiter administrator;
b. a computer readable program code means for mapping of said job seeker information on a jobs database to generate list of matching jobs, by said recruiter administrator; and
c. a computer readable program code means for sending said job seeker information and said matching jobs information to said suitable recruiter.

29. The computer program product according to claim 27, wherein said computer readable program code means for selling of jobs by said recruiter comprises:
a. a computer readable program code means for contacting of said recruiter by said recruiter administrator;
b. a computer readable program code means for sending an email to said recruiter, if said recruiter is not available; and
c. a computer readable program code means for initiation of chat by said recruiter with said job seeker, if said recruiter is available.

30. The computer program product according to claim 29, wherein said computer readable program code means for initiation of chat by said recruiter comprises:
a. a computer readable program code means for displaying chat request on job seeker screen;
b. a computer readable program code means for deleting job seeker from recruiter interface if said job seeker declines chat request or does not respond; and
c. a computer readable program code means for initiating a chat by said recruiter with said job seeker if the job seeker accepts the chat request.

31. The computer program product according to claim 27, wherein said computer readable program code means for selling of jobs is at least one of: a net based interaction and a cellular phone network based interaction.

32. The computer program product according to claim 27, wherein said computer readable program code means for selling of jobs is employed simultaneously with a plurality of job seekers.

33. The computer program product according to claim 27, wherein said computer readable program code means for selling of jobs is employed simultaneously with a plurality of recruiters.
